(19) United States
(12) Patent Application Publication
(10) Pub. No.: US 2025/0076935 A1
(43) Pub. Date: Mar. 6, 2025

(54) TOUCHSCREEN DIVE COMPUTER

(71) Applicant: Garmin International, Inc., Olathe, KS (US)

(72) Inventors: Alexander J. Waller, Olathe, KS (US); Richard S. Allen, Raymore, MO (US); James E. Corbett, Cary, NC (US); Thedric D. Jones, Cary, NC (US); Caleb A. Pinter, Olathe, KS (US)

(21) Appl. No.: 18/800,652

(22) Filed: Aug. 12, 2024

Related U.S. Application Data
(60) Provisional application No. 63/579,642, filed on Aug. 30, 2023.

(51) Int. Cl. G06F 1/16; G06F 3/0354; G06F 3/041; G06F 3/044; G06F 3/04883

(52) U.S. Cl. CPC G06F 1/1656; G06F 3/03545; G06F 3/0412; G06F 3/0442; G06F 3/04883

(57) ABSTRACT

A dive computer comprises a display, a stylus, an electromagnetic touch panel, and a processor. The electromagnetic touch panel is configured to detect a position of the stylus and differentiate between a first and a second end of the stylus based on the first and second resonant frequencies of coils positioned within the stylus. The processor is configured to provide a writing function based on the position of the first end of the stylus, provide an erasing function based on the position of the second end of the stylus; and control the display to present an indication of the writing function and the erasing function.

### RELATED APPLICATION

This application claims priority to U.S. provisional application 63/579,542, filed Aug. 30, 2023, and entitled TOUCHSCREEN DIVE COMPUTER, the contents of which are hereby incorporated by reference herein in their entirety.

### BACKGROUND

Dive computers, whether handheld or wearable, are often used by divers for various functions while diving. Dive computers must be robust and water resistant to sustain the pressures incurred while diving. Many dive computers therefore have limited functionality to ensure proper environmental robustness.

### BRIEF DESCRIPTION OF THE DRAWINGS

Embodiments of the present invention are described in detail below with reference to the attached drawing figures, wherein:

FIG. 1 is a front view of an example dive computer configured in accord with various embodiments;

FIG. 2 is a side view of the dive computer of FIG. 1;

FIG. 3 is a rear view of the dive computer of FIGS. 1-2;

FIG. 4 is a front perspective view of the dive computer of FIGS. 1-3;

FIG. 5 is another front perspective view of the dive computer of FIGS. 1-4 showing an example stylus in a detached position;

FIG. 6 is a block diagram of the stylus of FIG. 5;

FIG. 7 is a block diagram of example components of the dive computer of FIGS. 1-5; and

FIG. 8 is an exploded view of the dive computer of FIGS. 1-5.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

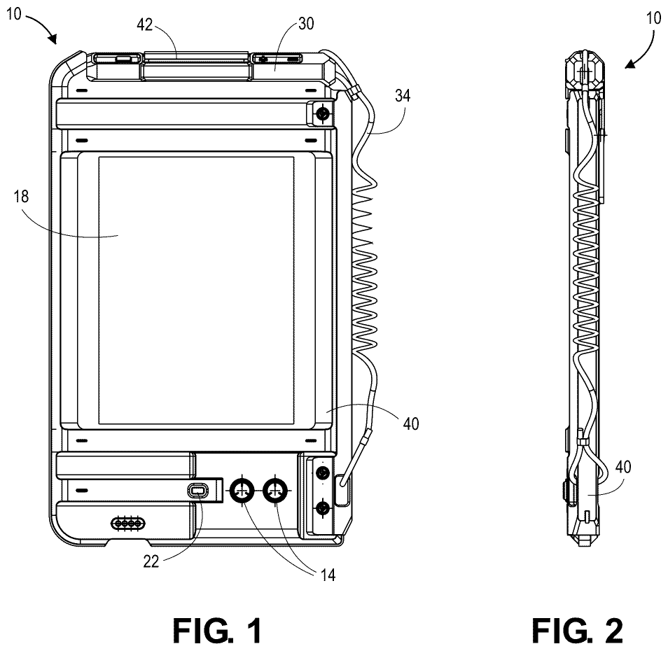

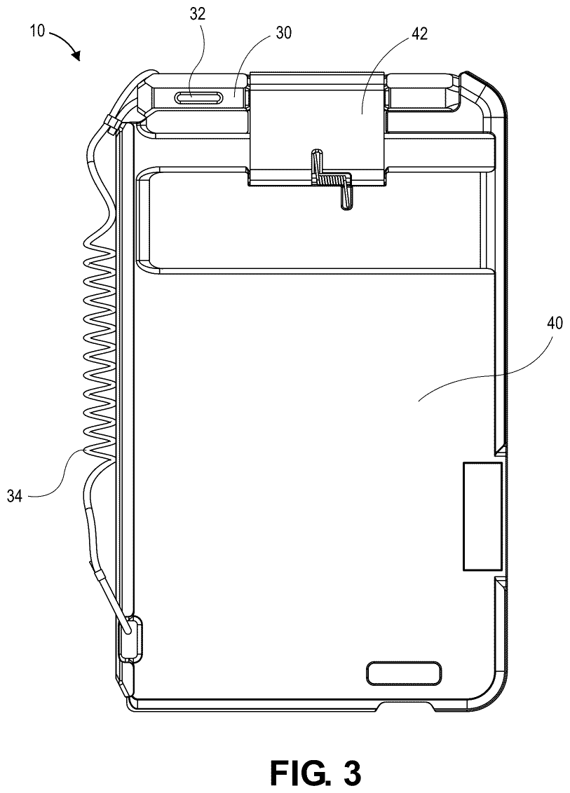

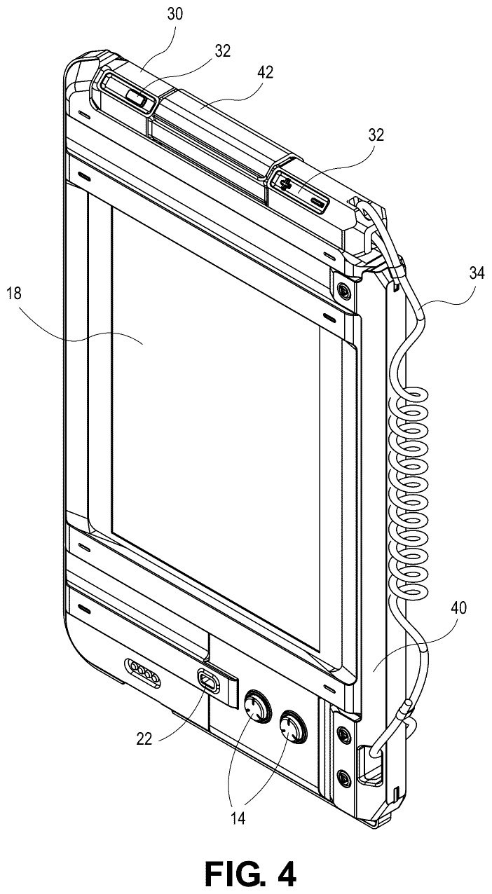

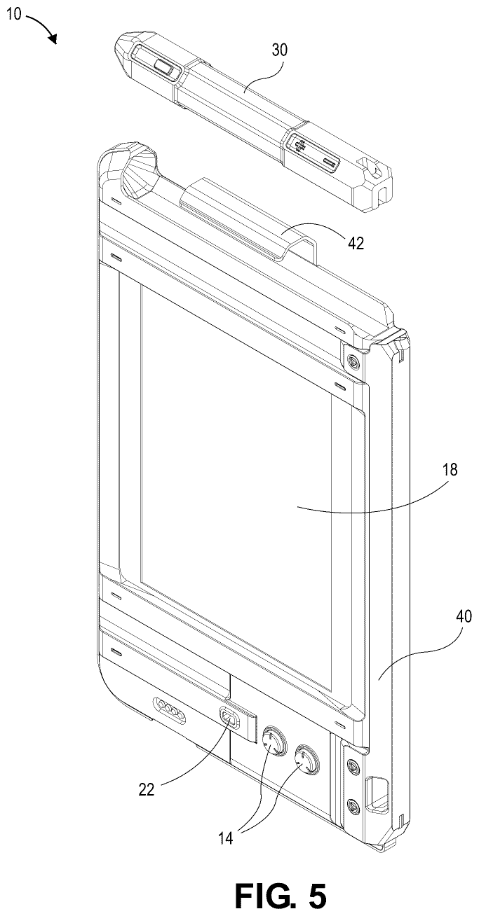

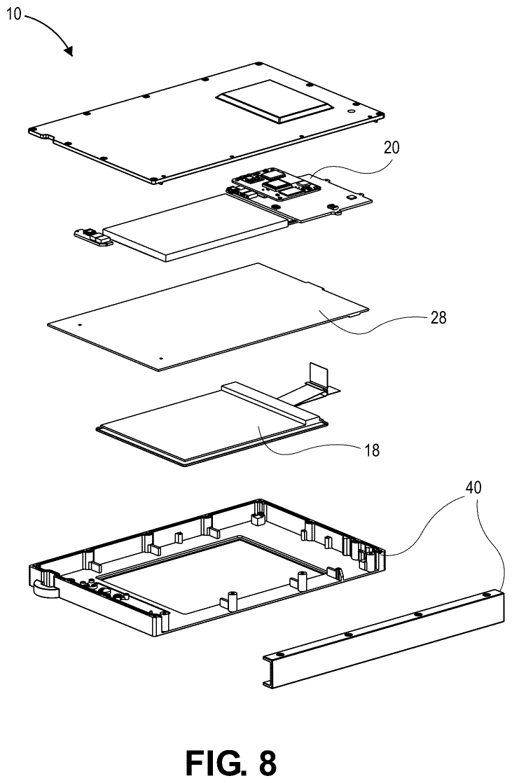

Referring to FIGS. 1-8, embodiments of the present invention provide a touchscreen dive computer 10. In one example, the dive computer is configured as a touchscreen slate. The dive computer 10 is a multi-use tool for reading, writing, and watching video underwater. It can be used to send and receive messages from other divers or the surface. It can be used to survey underwater, capture notes and drawings and save them, and to peruse and use pre, during, and post-dive checklists. In various configurations like thoughts illustrated in FIGS. 1-5, the dive computer 10 presents the form of a tablet or slate.

The dive computer 10 constructed in accordance with exemplary embodiments of the present technology will now be described in more detail. FIG. 7 illustrates one embodiment of the dive computer 10 and broadly comprises an input 14 for receiving data from a plurality of marine input sources 16; a display 18 for presenting information representative of at least some of the data from the marine input sources 16; and a processing system 20 coupled between the input 14 and the display 18. As described in more detail below, the processing system 20 implements a plurality of modes of operation, each of which causes the display 18 to present information representative of data from selected ones of the marine input sources 16 and in selected formats. The dive computer 10 also comprises a mode selector 22 for permitting a user to select between the modes of operation and one or more outputs 24 for coupling with one or more output devices 26.

The input 14 may be any wireless or wired device or devices for receiving data from the input sources 16 and transferring this data to the processing system 20. The input 14 may comprise, for example, one or more buttons, switches, keys, dials, Ethernet ports, USB Ports, memory card slots, video ports, radio frequency (RF) receivers, infrared (IR) receivers, Wi-Fi receivers, Bluetooth devices, etc. In some examples, input 14 includes one or more styluses described above.

The marine input sources 16 provide data to the processing system 20 and may comprise any measurement devices, sensors, receivers, or other components that sense, measure, or otherwise monitor components of the environment. The marine input sources 16 may also include transmitters, receivers, transceivers, and other devices that receive data from external sources. For example, the marine input sources 16 may include an integrated or external weather receiver for receiving weather data from a weather source and/or a global positioning system (GPS) receiver or other satellite navigation receiver for receiving navigation signals. The marine input sources 16 may also comprise a receiver or other device for communicating with transmitters or other devices worn by other divers. The marine input sources 16 may be integrally formed with the dive computer 10, may be stand-alone devices, or may be a combination of both. For example, the sonar sounder may be integrated into the dive computer 10 or may be configured an external sounder module. Similarly, the radar scanner may be integrated into the dive computer 10 or be an external device. The marine input sources 16 may be operated and adjusted using controls on the dive computer 10 or may have their own controls. In some configurations, marine input sources 16 may include sonar communication capabilities like Garmin® SubWave™ and/or those disclosed in U.S. Patent Application Publication No. US20230182875 filed Dec. 15, 2021, which is incorporated by reference herein in its entirety. Thus, marine input sources 16 may include one or more sonar transducers 16a coupled with the processing system 20 to generate and receive underwater communication signals. In some examples, the underwater communication signals may include underwater positioning signals from buoys, other underwater devices, and the like, to allow the processing system 20 to determine its own location.

Marine input sources 16 can include environmental sensors that measure various water quality metrics. These sensors can include temperature sensors, salinity sensors, pH sensors, and particulate matter sensors. Temperature sensors can function by detecting changes in electrical resistance or voltage that correlate with temperature fluctuations in the environment. Salinity sensors measure the conductivity of the water, which increases as salt concentration increases. pH sensors work by measuring the voltage difference between two electrodes placed in the water, which varies with the hydrogen ion concentration, thereby indicating the pH level. Particulate matter sensors assess water clarity and contamination levels by measuring the scattering and absorption of light passed through the water. These sensors convert the physical or chemical properties of the water into data that the processing system 20 can use to correlate with drive metrics and water metrics, including the location of the dive computer 10 and corresponding water quality metrics.

The display 18 is coupled with the processing system 20 and is configured for displaying text, data, graphics, images and other information representative of data from the marine input sources 16 and other sources. In one example, the display 18 includes the potting described above to allow performance while diving. The display 18 may be a liquid crystal display (LCD), light-emitting diode (LED) display, light-emitting polymer (LEP) display, thin film transistor (TFT) display, gas plasma display, or any other type of display. The display 18 may be backlit such that it may be viewed in the dark or other low-light environments. The display may be of any size, and in one embodiment, is sized and configured to be held in one hand while diving, with a display size of between 7 and 14 inches diagonal.

In example configurations, the display 18 of the dive computer 10 includes an active and functional display that works at pressures from zero to 20 ATM (0-200 meters depth) without the protection of a thick cover lens. The display 18 includes a multi-step, fully-potted construction that eliminates problematic air bubbles and pockets. Instead of a conventional display stack (e.g., LCD, OLED, etc.) that may include air gaps and bubbles prone to failure under diving pressures, configurations of the present invention can employ an improved stack that eliminates or otherwise minimizes the presence of bubbles in the stack. In one example, the display 18 is completely potted to removal air. Removing all air balances the stack to enable the dive computer 10, and the display 18 itself, to function at 20 ATM. In one example, gaps in the display stack and/or backlight assembly are potted with liquid optical clear adhesive (LOCA) to prevent the buildup of air pockets.

The dive computer 10 can individually address pixels on the display 18, which makes the display 18 appear like an e-ink display but allows the dive computer 10 to partially redraw the screen. This allows the screen to achieve framerates as high as 200 fps by only drawing a portion of the screen at once. Such functionality can be useful, for example, when displaying media or video content.

The device computer 10 may include touchscreen functionality such as resistive, capacitive, or infrared touchscreen technologies, or any combination thereof. In some examples, dive computer 10 can include an EM touch panel 28 installed behind the display 18. This allows the user to control the dive computer 10 with a stylus 30 in and out of the water. Capacitive touch and other conventional touch technology does not function in water, especially not in salt water. The dive computer 10 includes a fully potted and air-free backlight for the display. Normal backlights include an airgap that can fail during diving.

The EM touch panel 28 utilized in the dive computer 10 employes electromagnetic (EM) induction technology. It is configured with a grid of conductive traces positioned behind the display 18 or in other relative positions to enable operation of the panel 28 in combination with display 18. The stylus 30 contains at least one inductive coil that, when near the EM touch panel 28, generates a magnetic field. This magnetic field induces electrical currents in the grid of traces, which are detected by the system's sensors. These sensors are capable of determining the location of the stylus 30 on the EM touch panel 28 by measuring the variations in electromagnetic fields and currents. This configuration allows the dive computer 10 to register inputs from the stylus 30 without direct contact with the panel surface, enabling operation in wet conditions where capacitive and resistive touch technologies are ineffective.

Additionally or alternatively, the stylus 30 may be equipped with sensors that are powered by the magnetic field generated by the EM touch panel 28. These sensors can detect and generate data concerning the movement and the amount of pressure applied by the stylus 30. As the stylus moves or pressure is applied, changes in the electromagnetic field interaction between the stylus and the panel are detected by these sensors. Additionally, in configurations where stylus 30 includes buttons, switches, or other inputs, data regarding the actuation of these inputs may be provided to EM touch panel 28 and dive computer 10. The data regarding these interactions, including movement, position, and behavior of the stylus 30 and information regarding operation of its inputs, are then converted into electromagnetic waves, which are transmitted back to the EM touch panel 28. Thus, depending on the configuration, position, movement, and behavior of the stylus 30 may be determined by the EM touch panel 28, the stylus 30, or combinations thereof.

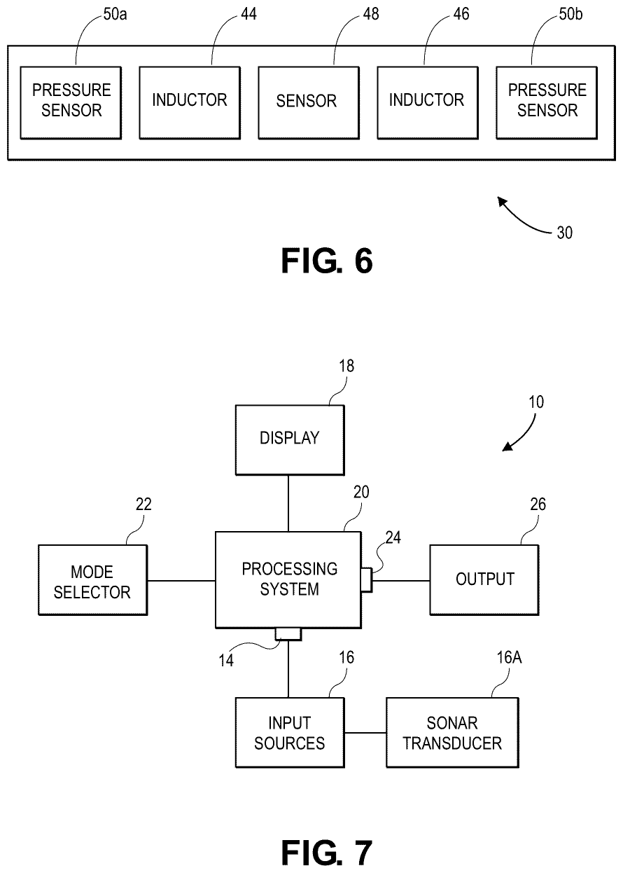

The stylus 30 may include a moveable tip, however, such a configuration can be difficult to use in adverse diving conditions. In some examples, like those shown in the illustrated Figures, stylus 30 may include one or more buttons 32 rated for diving suitability. In some examples, buttons 32 include a touch-sensitive area, such as a resistive or capacitive strip, that may sense pressure and/or proximity of the user's finger. As shown in the example of FIG. 6, stylus 30 may include a first inductive coil 44 with a first resonant frequency, and the other end of the stylus 30 acts as an eraser (and/or highlighter, brush, or other desired function) using a second inductive coil 46 with a second resonant frequency. As introduced above, stylus 30 may include sensor 48, such as one or more accelerometers, gyroscopes, magnetometers, compasses, combinations thereof, and the like. Sensor 48 can identify movement, position, and orientation of stylus 30.

The resonant frequencies of the coils 44, 46 are sufficiently different the EM panel 28 and/or dive computer 10 can tell the difference but sufficiently similar the EM panel 28 can detect both. When the diver approaches the display 18 with the stylus 30, the proximity of either the first coil 44 or the second coil 46 is detected by the EM touch panel 28 based on the specific resonant frequency emitted by the coil. If the first coil 44, associated with writing, is near, the EM touch panel recognizes its unique frequency and triggers the display to show a “writing mode” icon, typically symbolized by a pen or pencil icon. Conversely, if the second coil 46, designed for erasing, is in proximity, the panel detects its distinct frequency and updates the display to show an “erasing mode” icon, which might be represented by an eraser or a delete symbol. Furthermore, the stylus 30 is connected to the dive computer 10 via cord 34, but can also attach to the side of the dive computer 10 via one or more magnets. In some examples, multiple styluses may be provided, each having unique electrical characteristics, to enable multiple divers to utilize the same dive computer 10 with independent inputs.

In some configurations, stylus 30 includes one or more pressure sensors 50 configured to detect physical forces applied to the stylus 30. The pressure sensors 50 can utilize various technologies, such as piezoelectric, capacitive, resistive sensing elements, flex sensing elements, strain sensing elements, and/or MEMS sensors. Sensors 50 can detect deflection of the housing of the stylus 30 such as through strain, deflection, flex, or other deformation of the stylus 30. These sensors 50 convert detected physical forces into electrical signals, which can be processed by the internal circuitry of the stylus 30 or transmitted for processing by processing system 20.

The pressure sensors 50 may be positioned within the body of the stylus 30 to measure the force exerted on parts of the stylus 30 during use. In one example, stylus 30 includes pressure sensor 50a that is coupled with a tip of the stylus 30 to detect pressure, ranges of pressure, duration of pressure, and the like. The tip of the stylus 30 may be fixed and generally rigid or may be deformable or movable to assist with providing feel to the user. In either configuration, sensor 50a is configured to measure forces applied to the tip and/or their duration. Stylus 30 may additionally include a second pressure sensor 50b associated with parts of the stylus 30 other than the tip. For instance, pressure sensor 50b can measure forces, pressures, and durations applied to the side of the stylus to function as a button or other input, without requiring the use of physically movable buttons. Stylus 30 can include any number of pressure sensors 50 to provide any number of input forms to the user, including pressure sensors 50 on each end of stylus to assist with the writing, erasing, and other position-based functions described herein.

Pressure sensors 50 may work in combination with coils 44, 46 to provide enhanced functionality to the dive computer 10. For instance, as described herein, the computer 10 and the EM touch panel 28 may work in coordination with coils 44, 46 to detect the proximity of the stylus 30, and in particular the ends of the stylus, to the display 18. By utilizing information from the pressure sensors 50, the dive computer 10 can determine when the stylus 30 is making physical contact with the display 18 and the duration of such contact.

The stylus 30 allows divers to write or sketch while underwater. Divers can note observations of marine life, species, or unusual findings. It can serve as a tool for sketching rough maps during wreck or cave dives. Stylus 30 can be used in the writing mode to annotate displayed maps. Dive instructors might use it to draw diagrams or to note specific techniques. It facilitates written communication between divers, providing an alternative to hand signals. The dive computer 10 can also be used as a personal journal to document experiences and thoughts during a dive, annotate information on a chart, and the like.

In some examples, dive computer 10 includes a mount 42 to secure the stylus 30 to the dive computer 10. In the illustrated examples, mount 42 is a spring-loaded clip that mechanically holds the stylus 30 against the dive computer 10. The spring-loading of mount 42 enables the diver to easily remove the stylus 30 for us by pushing against mount 42. However, mount 42 may include any configuration suitable for retaining the stylus 30 during diving.

In some examples, mount 42 includes hall-effect sensor. The magnetic connection between the stylus 30 and the dive computer 10 acts as a hall effect sensor-based sleep mode initiator, i.e. when you lock the stylus 30 to the dive computer 10, the dive computer 10 goes into super-low-power mode. Pulling the stylus 30 free automatically wakes the dive computer 10 up for use. Although the stylus 30 may be configured as a pen-type pointing device, it may take other forms. For example, in some configurations, the stylus may be integrated with the diver's gloves, such that one finger provides a first set of electrical characteristics (to provide a first function) while a second finger provides a second set of electrical characteristics (to provide a second function). Additionally or alternatively, the stylus may take other physical forms, including circular and rounded instead of conventional pen shapes.

The processing system 20 controls the presentation of information on the display 18 and performs other functions described herein and can be implemented in hardware, software, firmware, or a combination thereof. The processing system 20 may include any number of processors, controllers, microprocessors, microcontrollers, programmable logic controllers (PLCs), field-programmable gate arrays (FPGAs), application specific integrated circuits (ASICs), or any other component or components that are operable to perform, or assist in the performance of, the operations described herein. The processing system 20 may also include memory elements for storing instructions or data. The memory elements may be a single component or may be a combination of components that provide the requisite storage functionality. The memory elements may include various types of volatile or non-volatile memory such as flash memory, optical discs, magnetic storage devices, SRAM, DRAM, or other memory devices capable of storing data and instructions. The memory elements may communicate directly with the processing system 20, or may communicate over a data bus or other mechanism that facilitates direct or indirect communication. The memory elements may optionally be structured with a file system to provide organized access to data existing thereon.

The memory may store one or more databases that may include bathymetric and navigation information, including nautical charts, to assist the user of the dive computer 10 while diving. The databases may also store information related to the locations and types of navigational aids including buoys, markers, lights, or the like. In some embodiments, the information related to navigational aids may be provided by the Coast Guard or other map data sources.

The processing system 20 may implement one or more computer programs that provide the operating modes described below and that control the display of information on the display 18 as described herein. The computer programs may comprise ordered listings of executable instructions for implementing logical functions in the processing system 20. The computer programs can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, communicate, propagate or transport the program for use by or in connection with the processing system 20 or other instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The output 24 may be any wired or wireless port, transceiver, memory slot, or other device for transferring data or other information from the processing system 20 to the output devices 26. The output devices 26 may be any devices capable of receiving information from processing system 20 or being controlled by the dive computer 10 such as a marine radio, beacon, lighting system, etc. The dive computer 10 may also include a piezoelectric speaker for providing audible instructions and feedback, a microphone for receiving voice commands, an infrared port for wirelessly receiving and transmitting data and other information from and to nearby electronics, and other information, and a cellular or other radio transceiver for wirelessly receiving and transmitting data from and to remote devices.

In addition to the input 14 and output 24, the dive computer 10 may also include a number of other I/O ports that permit data and other information to be communicated to and from the processing system 20. The I/O ports may include removable memory card slot, such as a micro SD card slot, or the like for receiving removable memory cards, such as microSD cards, or the like, and an Ethernet port for coupling processing system 20 with to another processing system such as a personal computer. Navigational software, cartographic maps and other data and information may be loaded in the dive computer 10 via the I/O ports, the wireless transceivers, or the infrared port mentioned above. The data may be stored in memory elements of processing system 20. In some embodiments, stored cartographic maps may be upgraded, downgraded, or otherwise modified in the background without interfering with the primary uses of the dive computer 10. If multiple processing systems 20 are used in dive computer 10, the upgrade, downgrade, or modification may be applied to all processing systems 20. Thus, for example, the various components of the dive computer 10 may be easily upgraded, downgraded, or modified without manually and tediously installing the same data on each of the components. Such functionality also ensures data uniformity among the various components of the dive computer 10.

The housing 40 of the dive computer 10 is engineered to protect internal components from moisture, vibration, and impact. In certain configurations, the housing 40 can be rated for use at depths up to 100 meters, and in some configurations up and beyond to 200 meters. This capability is facilitated by the use of materials such as plastic, nylon, aluminum, or combinations thereof, chosen for their lightweight and impact-resistant properties. The housing 40 incorporates gaskets or seals designed to make it substantially waterproof, maintaining the integrity of internal components under high-pressure conditions at depth. Additionally, the housing 40 can include mounting hardware for attachment to a diver or a remotely operated vehicle (ROV). The dimensions and configuration of the housing 40 are adaptable, allowing for variations in size, weight, and shape without compromising the functionality of the dive computer 10.

The dive computer 10 will have various forms of content, including dive checklists, note taking apps, videos, games, etc. The dive computer 10 can include underwater communication capabilities utilizing the communication techniques discussed above in connection with input 14 and input sources 16, to allow diver-to-diver communication and/or diver-to-boat communication. Underwater bathymetry maps could be included and location technologies can be used for navigation and positioning. The dive computer 10 can communicate with location sources, such as a sonar buoy or underwater location network, to determine its location (using time-of-flight or other similar techniques), so the dive computer 10 can indicate its position, and the position of other divers and vessels, on a map. The dive computer 10 can communicate with other devices, such as scanning sonar and real-time sonar systems, optical systems, ROVs, and the like, to present content for viewing by the diver.

In some examples, the dive computer 10 may include an integrated camera. The camera allows divers to capture still images or videos of intriguing marine life, unique underwater formations, or even document their dive adventures. If a diver comes across unfamiliar marine species or intriguing geological features, they can quickly snap a photo for later identification or study. Dive instructors can use it to record students' skills and techniques, providing visual feedback post-dive. The combination of note-taking and imaging capabilities means divers can annotate their photos directly, adding context or observations on-the-spot. Additionally, the camera can assist in navigation, allowing divers to take reference photos of certain landmarks, ensuring they can recognize and revisit specific locations. Photographs and other recorded content can be geo-located.

The dive computer 10, when integrated with positional awareness and mapping features, offers divers an underwater navigational tool. Dive computer 10 can determine its position through reception of positioning signals, such as sonar-based timing or positioning signals transmitted by buoys, surface vessels, underwater landmarks, other divers, etc. Divers can pinpoint their exact location relative to underwater landmarks, reefs, wrecks, or dive entry/exit points. This functionality can assist in safely navigating complex underwater terrains, such as intricate cave systems or large wreck sites. Instructors or dive leaders can utilize the dive computer 10 to plan routes, ensuring all divers follow the intended path and avoid potential hazards. Additionally, if a diver becomes disoriented, the dive computer 10 can serve as a guide back to a predetermined meeting point or surface location. For those interested in marine biology or underwater archaeology, precise location data combined with notes or sketches can help in documenting and revisiting specific points of interest. The mapping capability also makes it easier for divers to share their routes and points of interest with others post-dive or even during dive using the communication capabilities of the dive computer 10.

In some examples, dive computer 10 includes an integrated dive planning application that utilizes the display 18, EM touch panel 28, and stylus 30 to assist divers in preparing and managing their dives. The display 18 presents interactive dive planning interfaces that allow the user to input desired depth, time, and location parameters, using the stylus 30 or other input methods. Divers can use the stylus 30 to draw routes directly on digital maps displayed on the dive computer 10, enter numerical data for dive parameters, or select specific features within the planning application. The stylus 30 may be used underwater to modify waypoints, extend or reduce bottom time, and recalibrate safety stops, all while at depth.

Having thus described various embodiments, what is claimed as new and desired to be protected by Letters Patent includes the following:

1. A dive computer comprising:
a display;
a stylus including a first inductive coil presenting a first resonant frequency and a second inductive coil presenting a second resonant frequency, wherein the first inductive coil is associated with a first end of the stylus and the second inductive coil is associated with a second end of the stylus;
an electromagnetic touch panel associated with the display, the electromagnetic touch panel configured to detect a position of the stylus and differentiate between the first and second end of the stylus based on the first and second resonant frequencies of the coils;
a processor coupled with the display and electromagnetic touch panel, the processor configured to;
provide a writing function based on the position of the first end of the stylus;
provide an erasing function based on the position of the second end of the stylus; and
control the display to present an indication of the writing function and the erasing function; and
a housing retaining the display, electromagnetic touch panel, and processor, the housing having a depth dive rating of at least 100 meters.

2. The dive computer of claim 1, further including a sonar transducer coupled with the processor, wherein the sonar transducer is controlled by the processor to generate underwater communication signals.

3. The dive computer of claim 1, further including a sonar transducer, wherein the sonar transducer is configured to receive positioning signals and the processor is configured to determine a location of the dive computer based on the received positioning signals.

4. The dive computer of claim 2, wherein the processor is configured to control the display to present a map corresponding to the determined location of the dive computer.

5. The dive computer of claim 3, wherein the processor is configured to annotate the displayed map using the writing function.

6. The dive computer of claim 3, wherein the processor is configured to provide a navigation function based on the determined location.

7. The dive computer of claim 1, further including a mount and a hall-effect sensor associated the housing, wherein the hall-effect sensor is configured to detect the presence of the stylus and the processor is configured to wake the dive computer from a sleep mode when the stylus is removed from the mount.

8. The dive computer of claim 1, wherein the display includes a fully-potted display assembly.

9. The dive computer of claim 1, wherein the stylus further includes a pressure sensor configured to detect physical pressure applied to the first end of the stylus.

10. A dive computer comprising:
a sonar transducer;
a display;
a stylus including:
a first inductive coil presenting a first resonant frequency;
a second inductive coil presenting a second resonant frequency, wherein the first inductive coil is associated with a first end of the stylus and the second inductive coil is associated with a second end of the stylus; and
a first pressure sensor configured to detect physical pressure applied to the first end of the stylus;
an electromagnetic touch panel associated with the display, the electromagnetic touch panel configured to detect a position of the stylus and differentiate between the first and second end of the stylus based on the first and second resonant frequencies of the coils;
a processor coupled with the sonar transducer, the display and the electromagnetic touch panel, the processor configured to;
provide a writing function based on the position of the first end of the stylus and the pressure detected by the first pressure sensor;
provide an erasing function based on the position of the second end of the stylus; and
control the display to present an indication of the writing function and the erasing function; and
control the sonar transducer processor to generate underwater communication signals; and
a housing retaining the display, electromagnetic touch panel, and processor, the housing having a depth dive rating of at least 100 meters.

11. The dive computer of claim 10, wherein the sonar transducer is configured to receive positioning signals and the processor is configured to determine a location of the dive computer based on the received positioning signals.

12. The dive computer of claim 11, wherein the processor is configured to control the display to present a map corresponding to the determined location of the dive computer.

13. The dive computer of claim 12, wherein the processor is configured to annotate the displayed map using the writing function.

14. The dive computer of claim 10, wherein the stylus further includes a second pressure sensor configured to detect pressure applied to a part of the stylus spaced from the first end.
